(19) United States
(12) Patent Application Publication
(10) Pub. No.: US 2011/0135835 A1
(43) Pub. Date: Jun. 9, 2011

(54) METHOD FOR DEPOSITING A CARBON NANOTUBE THIN FILM COATING ON AN ARBITRARY SUBSTRATE DIRECTLY FROM CHEMICAL VAPOR DEPOSITION SYNTHESIS

(75) Inventors: Hyungbin Son, Seoul (KR); Jing Kong, Winchester, MA (US); Mario Hofmann, Somerville, MA (US); Ya-Ping Hsieh, Cambridge, MA (US)

(73) Assignee: MASSACHUSETTS INSTITUTE OF TECHNOLOGY, Cambridge, MA (US)

(21) Appl. No.: 12/796,281

(22) Filed: Jun. 8, 2010

Related U.S. Application Data
(60) Provisional application No. 61/185,034, filed on Jun. 8, 2009.

(51) Int. Cl. B05D 1/12; B01J 19/08; B05D 5/12; B05B 1/02; B05C 11/00; B82Y 99/00; B82Y 40/00

(52) U.S. Cl. 427/457; 427/180; 427/122; 118/300; 118/620; 977/750; 977/842

(57) ABSTRACT

A method includes generating an aerosol comprising a plurality of catalyst particles from a precursor solution comprising a carbon source and a catalyst, transmitting the plurality of catalyst particles through a reaction zone extending along a temperature profile including at least one temperature sufficient to induce in each of the plurality of catalyst particles growth of a plurality of carbon nanotubes, and positioning at least one substrate along the temperature profile and at least partially outside of the reaction zone at a position to collect a portion of the plurality of carbon nanotubes on a surface of the at least one substrate.

### RELATED APPLICATIONS

This application claims the benefit of provisional patent application Ser. No. 61/185,034, filed Jun. 8, 2009, the disclosure of which is hereby incorporated herein by reference in its entirety.

This invention was made with government funds under Contract No. HR0011-07-3-0002 awarded by DARPA. The U.S. Government has rights in this invention.

### FIELD OF THE DISCLOSURE

The present invention relates to a method for depositing a carbon nanotube thin film on a substrate.

### BACKGROUND

Single-walled carbon nanotube (SWNT)-based monolayer or submonolayer thin films on substrates represent a material platform that is attractive for many applications, such as thin film transistors for display and flexible electronics, transparent electrodes, substrates for neuron cell growth and stimulation, and the like. In order to obtain such a thin film of SWNTs on substrates, most approaches are solution-based. For example, a bulk amount of SWNT material is purified and dispersed in solution and is deposited on the substrate afterward via different techniques, such as drop casting, spraying, or vacuum filtration. The purification and dispersion steps are both costly and time consuming. More importantly, due to the sonication treatment during these steps, defects are created along the length of the SWNTs and the nanotubes are cut to an average length of 1 micrometer (μm) or less. As a result, the electrical properties of these SWNT films are degraded. There is a need for an effective and efficient technique to deposit a carbon nanotube thin film coating on an arbitrary surface such that the resultant coating does not suffer from unwanted defects.

### SUMMARY OF THE DETAILED DESCRIPTION

In accordance with an exemplary and non-limiting embodiment, a method comprises generating an aerosol comprising a plurality of catalyst particles from a precursor solution comprising a carbon source and a catalyst, transmitting the plurality of catalyst particles through a reaction zone extending along a temperature profile comprising at least one temperature sufficient to induce in each of the plurality of catalyst particles growth of a plurality of carbon nanotubes, and positioning at least one substrate along the temperature profile and at least partially outside of the reaction zone at a position to collect a portion of the plurality of carbon nanotubes on a surface of the at least one substrate.

In accordance with another exemplary and non-limiting embodiment, an apparatus an apparatus comprises a spray nozzle for transmitting an aerosol comprising a plurality of catalyst particles from a precursor solution comprising a carbon source and a catalyst, a growth chamber comprising a temperature profile along which is transmitted the plurality of catalyst particles wherein the temperature profile comprises at least one temperature sufficient to induce in each of the plurality of catalyst particles growth of a plurality of carbon nanotubes, and at least one substrate along the temperature profile at a position to collect a portion of the plurality of carbon nanotubes on a surface of the at least one substrate.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIGS. 1A and 1B are block representations of an apparatus configuration according to one embodiment of the disclosure.

FIG. 2A is an illustration of integrated G band intensities for different growth temperatures according to exemplary embodiments of the disclosure.

FIGS. 2B-2D are illustrations of atomic force microscopy (AFM) images representative of sample morphology for single-walled carbon nanotube (SWNT) thin films corresponding to the growth temperatures of FIG. 2A according to exemplary embodiments of the disclosure.

FIGS. 3A-3E are illustrations of AFM images representative of growth results for SWNTs at differing positions in a furnace according to exemplary embodiments of the disclosure.

FIG. 3F is an illustration of the diameter distribution of the SWNTs of FIG. 3D.

FIG. 4A is an illustration of spatial temperature distribution along the x direction of a growth chamber according to exemplary embodiments of the disclosure.

FIG. 4B is an illustration of spatial temperature gradient distribution in the radial direction of a growth chamber according to exemplary embodiments of the disclosure.

FIG. 4C is an illustration of spatial temperature gradient distribution along the x direction of a growth chamber according to exemplary embodiments of the disclosure.

FIG. 5A is an illustration of an AFM image of SWNTs according to exemplary embodiments of the disclosure.

FIG. 5B is an illustration of length distributions of the SWNTs of FIG. 5A according to exemplary embodiments of the disclosure.

FIG. 5C is an illustration of an AFM image of SWNTs according to exemplary embodiments of the disclosure.

FIG. 5D is an illustration of length distributions of the SWNTs of FIG. 5C according to exemplary embodiments of the disclosure.

FIG. 6 is an illustration of a method according to exemplary embodiments of the disclosure.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

In accordance with exemplary embodiments described herein, a floating catalyst chemical vapor deposition (CVD) method is used to directly coat a substrate with single-walled carbon nanotube (SWNT) thin films. The catalyst is dispersed into an aerosol produced by electrospraying to provide small, highly charged droplets with a narrow diameter distribution when using a strong applied electrical field. In an exemplary and non-limiting embodiment, the droplets are comprised of an ethanol solution containing ferrocene. In such a configuration, the ethanol provides a carbon precursor while the ferrocene provides the catalyst for SWNT growth. After dispersion into a hot zone, such as a furnace, the nanotubes are generated as they are carried by the gas flow and deposited on a low temperature surface at the downstream end of the furnace. As described more fully below, atomic force microscopy (AFM) and Raman spectroscopy may be employed as a characterization technique to examine where the nanotubes deposit inside the furnace.

In accordance with exemplary embodiments described herein, the SWNTs are substantially deposited at specific locations, instead of uniformly coating the inside of the furnace. By controlling a variety of forces acting on the floating SWNTs, preferential deposition SWNTs having desirable properties and formed at specific locations may be achieved. As confirmed by comparison of Raman and AFM size distributions described below, an optimization of the CVD process parameters results in SWNT films consisting of mostly isolated SWNTs. Furthermore, in situ SWNT sorting is made possible whereby the attributes of resulting SWNT films may be sorted based on the location of the substrate upon which the SWNT film is formed.

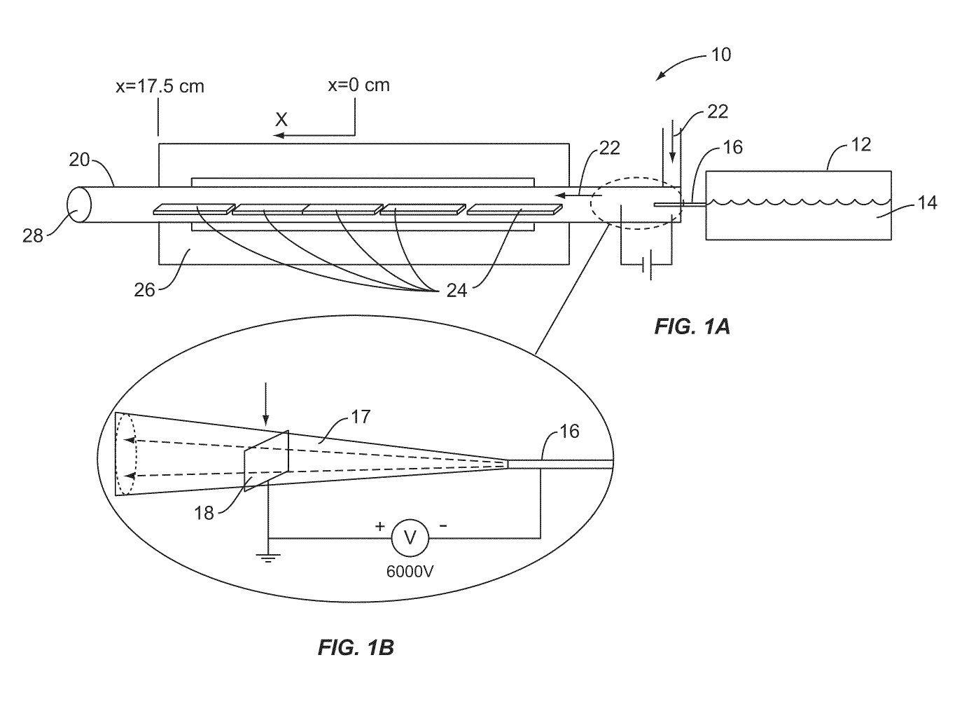

FIG. 1A is a schematic diagram of an apparatus 10 for practicing various exemplary embodiments described below. A syringe pump 12 holds a precursor solution 14. The precursor solution 14 may be formed of any solution comprising a carbon source and a catalyst for promoting the growth of carbon nanotubes when dispersed as described below. In an exemplary embodiment, ethanol (˜99.9% pure) serves as the carbon source/carbonaceous precursor with 0.01 M ferrocene (˜99% pure, ˜1.86 mg ml⁻¹) used as the catalyst. A spray nozzle 16 is in operative physical contact with the syringe pump 12 and functions to extract and direct the precursor solution 14 as an aerosol mist in a generally linear direction away from the syringe pump 12. The precursor solution 14 is introduced into the spray nozzle 16. The precursor solution 14 is then dispersed into an aerosol 17 when the surface tension of the liquid/air interface is overcome by a strong electrostatic field, for example, on the order of 10⁶ Vm⁻¹, applied between the spray nozzle 16 at, for example, −6 kV, and a counter electrode 18 at, for example, ground, as illustrated in detail in FIG. 1B.

With continued reference to FIG. 1A, subsequently small droplets of the precursor solution 14 are extracted from the spray nozzle 16. In an exemplary embodiment, the precursor solution 14 is delivered to the spray nozzle 16 at a flow rate of between approximately 7 ml h⁻¹ and 9 ml h⁻¹ or, more particularly, at approximately 8 ml h⁻¹. The atomized and charged droplets of the precursor solution 14 are carried into a growth chamber 20 by a flow 22 of gas. In an exemplary embodiment, the gas is comprised of an argon/hydrogen mixture (with a volume ratio of approximately 61/39 and a total flow rate of approximately 1000 sccm). Silicon substrates 24 with approximately 100 nm thermally grown oxide (SiO₂/Si) are placed inside the growth chamber 20 to collect grown nanotubes. As illustrated, the growth chamber 20 is partially encapsulated within a furnace 26 and extends substantially linearly away from the syringe pump 12 terminating in an end 28. In an exemplary embodiment, the end 28 extends beyond the furnace 26.

Deposition of SWNTs is accomplished with varying resulting attributes throughout the furnace 26. This in situ separation is the result of the placement of the silicon substrates 24 along the entire length of the furnace 26. In the description that follows, the length of the furnace 26 is 35 cm with measurements based upon an origin located at a midpoint along the furnace 26 (x=0) and extending for 17.5 cm in each direction along the growth chamber 20 (35 cm).

In the examples that follow, experimental results are presented wherein the apparatus 10 of FIG. 1A operates at three growth temperatures, 950, 1000, and 1100° C. Specifically, for individual batches comprising a plurality of the silicon substrates 24 simultaneously situated along the growth chamber 20, the heat of the furnace 26 is configured to produce a temperature along the growth chamber 20 approximately corresponding to one of the aforementioned temperatures. The growth time, beginning at the introduction of the precursor solution 14 into the growth chamber 20 and extending until the catalyst delivery is turned off and the samples are cooled down under Ar/H₂ gas flow 22, is approximately 4 minutes. After the CVD process, AFM imaging and confocal Raman mapping across the surface of the silicon substrates 24 are used to characterize the SWNT deposition. The temperature inside the furnace 26 and substrate temperatures at different locations are measured using two K-type thermocouples that reach into a reaction zone of the growth chamber 20.

In order to characterize the materials deposited on the silicon substrates 24, confocal Raman spectroscopy (with a laser spot of ˜1 μm²) is used to scan a line across the silicon substrates 24 with a step size of 35 μm using an excitation wavelength of 532 nm. The G band, a Raman mode at around 1600 cm⁻¹ and associated with the in-plane vibrations of sp² carbonaceous species, is used to examine the deposition of the obtained material. The intensity variation of this Raman feature across the sample provides an overview of the spatial distribution of the nanotube density.

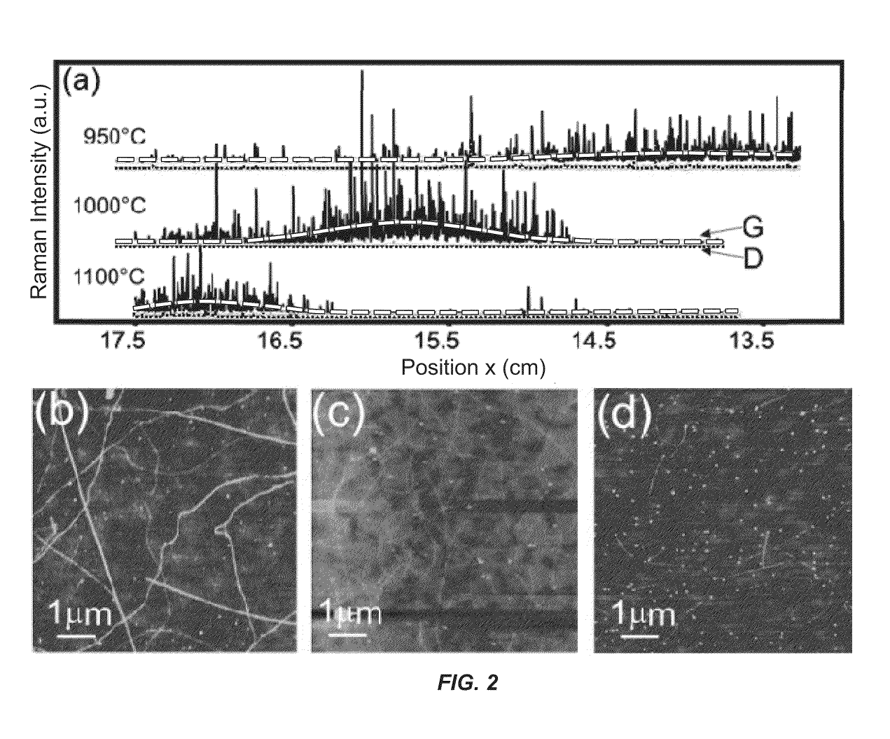

FIG. 2A is an illustration of the integrated G band intensity (1500-1650 cm⁻¹) (dashed line) versus position x for three different growth temperatures. It can be seen that most carbonaceous material is deposited in the region close to the downstream end of the furnace 26 (x=17.5 cm, FIG. 1A). In other locations, almost no G band intensity is observed.

The integrated intensity of the Raman D band (dotted line) around 1300 cm⁻¹ (from 1250 to 1400 cm⁻¹) versus position x for these three growth temperatures are also Illustrated underneath the corresponding G band distribution. The D band in the Raman spectrum is known to arise from the defects in sp² structures. The average ratio of the G/D band intensities is about 50. This low D band intensity indicates that the samples contain high quality graphitic structures and a low content of amorphous carbon material. FIGS. 2B-2D are AFM images of a silicon substrate 24 positioned approximately at the center of the density distributions illustrated in FIG. 2A for 950° C. (FIG. 2B), 1000° C. (FIG. 2C), and 1100° C. (FIG. 2D) growth temperatures. As is evident, a high proportion of the structures deposited on the surface of the silicon substrates 24 are SWNTs. The average spatial distribution of each of the G band intensities (dashed lines in FIG. 2A) follows a Gaussian distribution and its center shifts toward the downstream edge or end of the growth chamber 20 as the growth temperature increases. In contrast, the width of the fitted Gaussian distribution becomes larger at lower growth temperatures. From the G band intensity distribution in FIG. 2A it can be seen that in order to obtain a uniform coating on the silicon substrate 24, the sample size would have to be limited to 2 cm for the 1000° C. case, whereas for the 950° C. growth, there is a wider range (>3 cm) for an even coat of SWNTs on the silicon substrate 24.

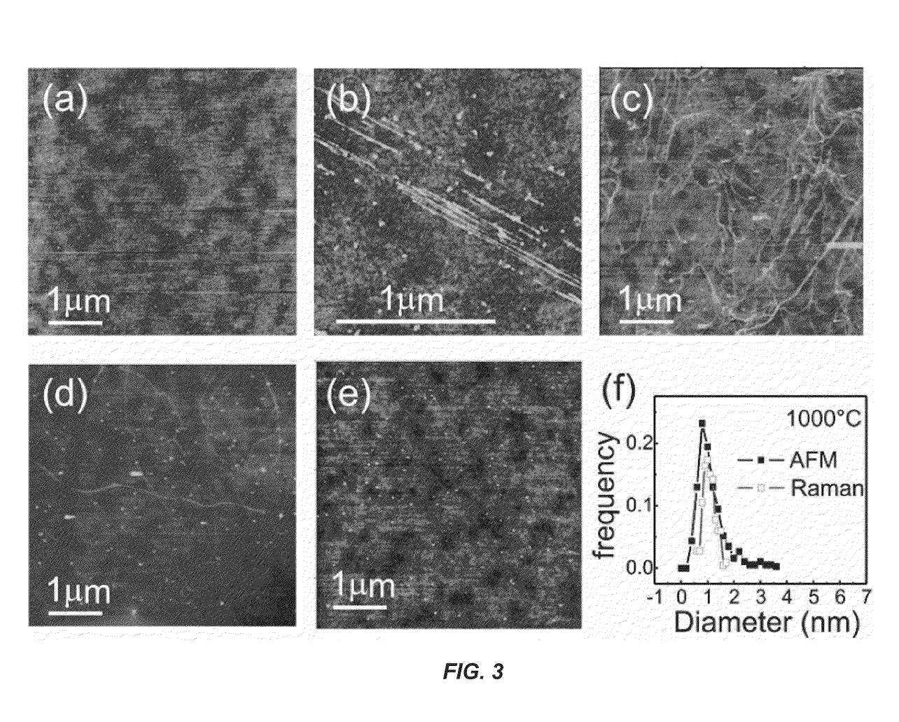

FIGS. 3A-3E illustrate a series of AFM images taken of the silicon substrates 24 at different locations inside the furnace 26 for the growth temperature of 1000° C. FIG. 3A corresponds to a silicon substrate 24 at position x=14 cm. FIG. 3B corresponds to a silicon substrate 24 at position x=14.5 cm. FIG. 3C corresponds to a silicon substrate 24 at position x=15.5 cm. FIG. 3D corresponds to a silicon substrate 24 at position x=16.5 cm. FIG. 3E corresponds to a silicon substrate 24 at position x=17.5 cm. The density of SWNTs in FIGS. 3A-3E is consistent with the measured variation of the average integrated G band intensity in FIG. 2A.

The diameter distribution of the nanotubes derived independently from analysis of AFM images from 450 nanotubes and their Raman characterization is illustrated in FIG. 3F. Confocal Raman spectra with eight different laser excitation wavelengths (457, 488, 514, 532, 594, 647, 675, and 780 nm) were taken in a 200 μm×40 μm area in the same spatial region as the AFM images of FIGS. 3A-3E to ensure a representative coverage of nanotubes with different resonance conditions. The diameter of each individual nanotube was determined from the frequency of its RBM mode using the formula A=218.8/B−15.9, where A and B are the frequency of the RBM mode and the diameter, respectively. As is evident, good agreement between the two diameter distributions derived by AFM and Raman measurements is observed. This agreement indicates the absence of a significant amount of nanotube bundles. Specifically, if a significant number of nanotube bundles were present, the diameter derived from the AFM height measurement—representing the diameter of the entire bundle—would differ from the distribution from the Raman analysis, which only probes the diameters of individual SWNTs within a nanotube bundle. It is therefore evident that for the growth at 1000° C., most deposited nanotubes are isolated SWNTs. This high probability of depositing isolated SWNTs may be attributed to the use of a dilute concentration of both the ferrocene catalyst and the carbon precursor in the precursor solution 14.

As a result, the as-grown SWNT aerosol concentration inside the furnace 26 is much reduced and the nanotubes have less chance to interact with each other in the gas phase to form bundles. Furthermore, the diameter distribution is fairly narrow, ˜±0.3 nm, and the average diameter of the resulting nanotubes is <1 nm, which makes these nanotubes useful for optical and spectroscopic applications.

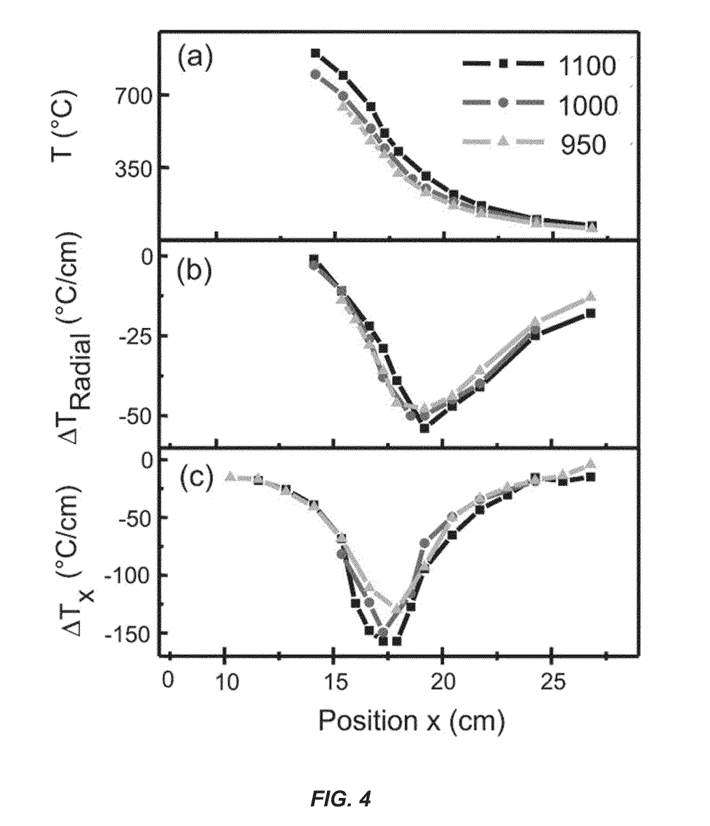

In order to understand the distribution of SWNT density as a function of their position on the silicon substrate 24, thermocouple temperature measurements are conducted across the cross section of the growth chamber 20 (termed radial direction as the chamber is generally cylindrical) and along the length of the growth chamber 20 (referenced as x-direction in FIG. 1A). FIG. 4A is an illustration of the gas-temperature, FIG. 4B is an illustration of the temperature gradients ΔT in the radial, and FIG. 4C is an illustration of the temperature gradients ΔT in the x-direction, all as a function of position x along the growth chamber 20.

The radial temperature gradient is approximated by taking the difference of the gas and the silicon substrate 24 temperature at the same x. It is expected that the walls (which are subjected to a more intimate heat transfer from the furnace 26 and the environment) are cooling down faster outside the heating zone of the furnace 26 than the gas flow 22, and indeed it can be seen in FIG. 4C that ΔT in the radial direction increases in magnitude towards the downstream edge of the furnace 26. This temperature gradient gives rise to a thermophoretic force on the floating SWNTs in the radial direction, driving them towards the colder silicon substrate 24 and depositing the SWNTs on the silicon substrate 24. In addition, the floating aerosol particles (including SWNTs) in the gas flow 22 experience other types of driving forces that will move them in the x-direction. First, a diffusion force arises as a result of a density gradient of the produced SWNTs along the furnace 26 that directs the SWNTs from the reaction zone, where they are grown, towards the two ends of the furnace 26 tube. Second, a thermophoretic force in the x-direction arises due to the changes in temperature along the x direction as shown in FIG. 4A that give rise to a motion of the particle away from the hot reaction zone. Lastly, the gas flow 22 exerts a drag force on the particle towards the downstream direction of the gas flow 22. This drag force is strongly dependent on the size of the particles, especially if they become comparable to the mean free path of the gas molecules. With reference to FIG. 3B, it is evident that as one follows the gas flow 22 direction from upstream to downstream, the materials which precipitate on the silicon substrate 24 first consist of very short, broken pieces of SWNTs. This may be because these pieces are short, the drag force on them due to the gas flow is small. At the same time, the small mass of these particles gives them larger mobility in small temperature gradients, which appear closer to the reaction zone. As a result these fragments start to precipitate at an earlier location than larger nanotubes.

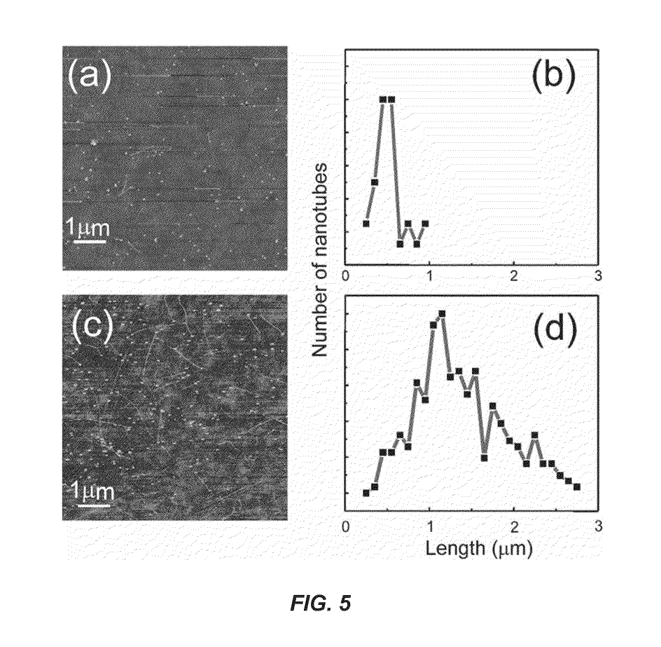

Longer nanotubes, on the other hand, experience (apart from the diffusion and thermophoretic forces) a stronger drag force and are carried further downstream and deposit at a later position. This observed characteristic allows the floating catalyst CVD to be used for in situ separation of SWNTs by applying varying forces to different types of SWNTs. It is therefore possible for SWNTs of different lengths to be spatially separated. Indeed, FIGS. 5A-5D illustrate this point. FIGS. 5A and 5B are AFM images of SWNTs grown at 1100° C. and collected at 16.2 cm and 17.4 cm, respectively. Growth conditions correspond to those described with reference to FIG. 2A. A high ethanol decomposition rate at this temperature results in carbon coating over the catalyst (as indicated by the increased size of catalyst clusters in FIGS. 5A and 5C) and therefore the catalyst lifetime becomes shorter. As a result, the SWNTs are much shorter compared to the 950 and 1000° C. cases. These short SWNTs simplify the observation of the length dependent separation by AFM. FIGS. 5B and 5D show the length distributions of the SWNTs collected at the same positions (28 SWNTs and 288 SWNTs are used for the distributions, respectively). It can be seen that SWNTs with an average length<1 μm precipitate earlier than SWNTs with an average length>1 μm.

Analysis of the various forces acting on the floating aerosol particles (SWNTs and catalyst particles, etc.) helps to explain other experimental observations as well. For example, if the growth conditions are not tuned well (i.e., when using too high concentrations of carbon precursor solution 14), amorphous carbon will deposit even at the upstream edge of the furnace 26 (region −16.5 to −17.5 cm). This can be understood in the following scenario: the floating amorphous carbon particles are too small to experience a significant drag force from the gas flow 22. Since there are diffusive and thermophoretic forces in both directions along the growth chamber 20 they can drive the particles from the hot zone to both ends of the furnace 26. As a result, some of these particles are moving against the flow 22 and are finally deposited at the upstream cold region.

Finally, comparison of the SWNT spatial distributions of the three growth temperatures provides further insights into the growth of the SWNTs. As described above with reference to FIG. 2A, the center of the average spatial distribution shifts toward the downstream edge as the growth temperature increases. On the other hand, FIGS. 4B and 4C illustrate that both the axial and the radial temperature gradients are very similar in the regions of interest for the three growth temperatures (see FIG. 4A) and cannot explain the observed trends. However, the diffusion of nanotubes away from the reaction zone is expected to increase with increasing temperature and indeed it is evident that nanotubes grown at 1100° C. deposit further downstream than the ones grown at 1000 or 950° C. This result also sheds some light on the lesser importance of drag force compared to diffusivity: since the average length of the nanotubes grown at 950° C. is much higher than the nanotubes grown at 1100° C., those long nanotubes would experience larger drag force and deposit further downstream, which would cause the opposite trend to the increase in diffusion explained before. Instead, the temperature and inverse length dependences of the diffusivity prevail and cause the observed tendency in the center position of the density distribution.

As described above, a floating catalyst CVD is used to directly deposit very thin films of SWNTs on substrates, which is important for many applications. If a low nanotube concentration condition (i.e., low catalyst concentration and low ethanol injecting rate) is maintained, an isolated nanotube film can be obtained. The deposition of floating SWNTs on the substrate can be explained by analyzing the forces acting on them. A length separation of nanotubes deposited at different positions is observed which allows for in situ separation of SWNTs.

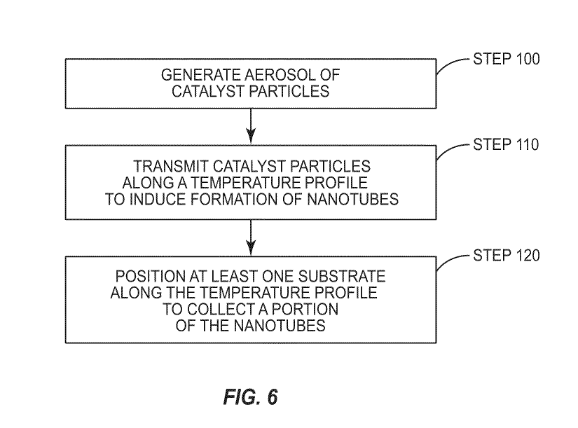

FIG. 6 is an illustration of a method according to an exemplary embodiment. First, there is generated an aerosol of catalyst particles (step 100). As described above, the aerosol is formed from the precursor solution 14 comprising a carbon source and a catalyst. In an exemplary embodiment, the precursor solution 14 is drawn from the syringe pump 12 and sprayed into the growth chamber 20 via the spray nozzle 16. The growth chamber 20 is substantially surrounded by the furnace 26.

Upon exiting the spray nozzle 16, the aerosol formed of the catalyst particles is transmitted in a generally linear direction away from the spray nozzle 16 and towards the end 28 of the growth chamber 20 (step 110). The aerosol travels within the flow 22 of gas from a position proximate to the spray nozzle 16 and extending along the length of the growth chamber 20 and through the end 28 of the growth chamber 20. The heating of the growth chamber 20 by the furnace 26 generates a zone where a certain temperature is achieved. This temperature is sufficient to cause the formation of carbon nanotubes within the catalyst particles and is termed a reaction zone.

Next, a substrate, such as a silicon substrate 24, is placed at a position outside of the reaction zone proximate to the end 28 whereat a portion of the catalyst particles are deposited as a thin film upon the silicon substrate 24 (step 120). The result is a silicon substrate 24 covered with a thin film of carbon nanotubes wherein the nanotubes have substantially similar attributes. By controlling the position of the silicon substrate 24, the attributes of the deposited nanotubes may be preferentially selected. In accordance with an exemplary embodiment, the silicon substrate 24 is maintained at a temperature lower than the temperature necessary to generate nanotubes.

Those skilled in the art will recognize improvements and modifications to the preferred embodiments of the present invention. All such improvements and modifications are considered within the scope of the concepts disclosed herein and the claims that follow.

What is claimed is:

1. A method comprising:
generating an aerosol comprising a plurality of catalyst particles from a precursor solution comprising a carbon source and a catalyst;
transmitting the plurality of catalyst particles through a reaction zone extending along a temperature profile comprising at least one temperature sufficient to induce in each of the plurality of catalyst particles growth of a plurality of carbon nanotubes; and
positioning at least one substrate along the temperature profile and at least partially outside of the reaction zone at a position to collect a portion of the plurality of carbon nanotubes on a surface of the at least one substrate.

2. The method of claim 1 wherein the carbon source comprises an ethanol solution.

3. The method of claim 1 wherein the catalyst comprises ferrocene.

4. The method of claim 1 wherein transmitting the plurality of catalyst particles comprises ejecting the aerosol into a gas flow.

5. The method of claim 4 wherein the gas flow is comprised of Ar/H₂.

6. The method of claim 4 wherein ejecting the aerosol comprises applying a voltage to a spray nozzle.

7. The method of claim 6 wherein the voltage is approximately 6000 V.

8. The method of claim 1 wherein the temperature profile comprises a maximum temperature not greater than approximately 1100° C.

9. The method of claim 1 wherein the at least one substrate is maintained at a temperature sufficient to substantially halt formation of additional carbon nanotubes after the plurality of catalyst particles are collected on the at least one substrate.

10. The method of claim 1 wherein positioning the at least one substrate comprises determining a position along a growth chamber at which a film formed by the portion of the plurality of carbon nanotubes collected on the surface of the at least one substrate comprises at least one desired property.

11. The method of claim 10 wherein the at least one desired property is selected from a group consisting of an average diameter of the plurality of carbon nanotubes, a desired electronic property of the plurality of carbon nanotubes, and an average length of the plurality of carbon nanotubes.

12. An apparatus comprising:
a spray nozzle for transmitting an aerosol comprising a plurality of catalyst particles from a precursor solution comprising a carbon source and a catalyst;
a growth chamber comprising a temperature profile along which is transmitted the plurality of catalyst particles wherein the temperature profile comprises at least one temperature sufficient to induce in each of the plurality of catalyst particles growth of a plurality of carbon nanotubes; and
at least one substrate along the temperature profile at a position to collect a portion of the plurality of carbon nanotubes on a surface of the at least one substrate.

13. The apparatus of claim 12 wherein the carbon source comprises an ethanol solution.

14. The apparatus of claim 12 wherein the catalyst comprises ferrocene.

15. The apparatus of claim 12 wherein transmitting the plurality of catalyst particles are transmitted via a gas flow.

16. The apparatus of claim 15 wherein the gas flow is comprised of Ar/H₂.

17. The apparatus of claim 15 wherein the aerosol is transmitted via an application of a voltage to the spray nozzle.

18. The apparatus of claim 17 wherein the voltage is approximately 6000 V.

19. The apparatus of claim 12 wherein the temperature profile comprises a maximum temperature not greater than approximately 1100° C.

20. The apparatus of claim 12 wherein the at least one substrate is maintained at a temperature sufficient to substantially halt formation of additional carbon nanotubes after the plurality of catalyst particles are collected on the at least one substrate.

21. The apparatus of claim 12 wherein the position of the at least one substrate comprises a position along the growth chamber at which a film formed by the portion of the plurality of carbon nanotubes collected on the surface of the at least one substrate comprises at least one desired property.

22. The apparatus of claim 21 wherein the at least one desired property is selected from a group consisting of an average diameter of the plurality of carbon nanotubes and an average length of the plurality of carbon nanotubes.
